(19) United States
(12) Patent Application Publication
(10) Pub. No.: US 2019/0095893 A1
(43) Pub. Date: Mar. 28, 2019

(54) POINT OF SALE DEVICE WITH ADDITIONAL SERVICE CAPABILITIES

(71) Applicants: Santosh Lachhman Achhra, Singapore (SG); Stanislav Tsikine, Foster City, CA (US); Sergey Paykis, Foster City, CA (US)

(72) Inventors: Santosh Lachhman Achhra, Singapore (SG); Stanislav Tsikine, Foster City, CA (US); Sergey Paykis, Foster City, CA (US)

(21) Appl. No.: 16/083,249

(22) PCT Filed: Mar. 8, 2016
(86) PCT No.: PCT/US2016/021391

§ 371 Date: Sep. 7, 2018

(51) Int. Cl. G06Q 20/20; G06Q 20/40

(52) U.S. Cl. CPC G06Q 20/202; G06Q 20/40

(57) ABSTRACT

A point of sale device includes additional hardware, circuitry and instructions to enable additional functionality to allow the point of sale device to request a service at the location of the point of sale device. An input on the point of sale device may be used to request a service.

### CROSS-REFERENCE TO RELATED APPLICATION

This application is a national phase application of international application serial no. PCT/US2016/021391, filed on Mar. 8, 2016, entitled, “Point of Sale Device with Additional Service Capabilities,” whose disclosure is incorporated by reference in its entirety herein.

### BACKGROUND

Point of sale terminals are physical devices which receive payment information, communicate it for authorization and receive a signal which indicates whether a transaction is authorized or not. Over time, point of sale devices have become more complex and able to execute additional tasks and provide additional security to the parties in the electronic commerce exchange.

At the same time, in many part of the world, services such as transportation is provided by others such as cab drivers or other drivers for hire. Obtaining such services operates in a variety of manners such as calling from telephone or cell phones, pre-arranging pick up times or using a web connected device to obtain a service. However, in many parts of the world, phones, computers and other sophisticated electronic devices are rare and expensive.

It would be useful be able to use the technical capabilities of a point of sale device to request a service. Further, it would be useful for service providers to be confident a user has sufficient means to pay for the service before the service is provided.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

A point of sale device is disclosed that includes additional circuitry to enable additional functionality. In one aspect, a point of sale device includes additional hardware, circuitry and instructions to enable additional functionality to allow the point of sale device to request a service at the location of the point of sale device. An input on the point of sale device may be used to request a service. The request may be communicated over a payment network. The service server may accept the request and communicate the payment data to an authorization server to ensure the payment is authorized. Assuming the payment is authorized, the service server communicate the service request to service providers where the service providers may select to accept the request to provide services. If the service provider is selected, the service provide may be notified and the requestor may be notified of the details of the service provider. After the service is complete, the service provider may be compensated and the service requestor may make the payment.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates a sample point of sale device;

FIG. 2 illustrates a sample point of sale device with additional circuitry to request a service;

FIG. 3 illustrates of diagram of the logic flow of the device;

FIG. 4 illustrates the computing devices in a sample system; and

FIG. 5 illustrates a sample graphical user interface.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

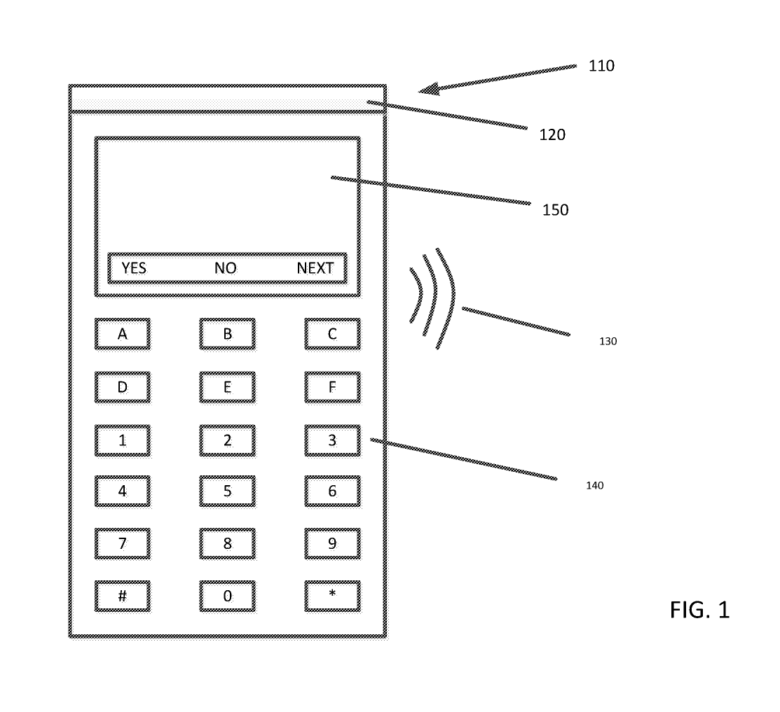

Referring to FIG. 1, a point of sale device 110 may be illustrated. Traditional point of sale devices take in an account number from a customer and communicate the account number along which a merchant identifier and a total to a transaction handler. The data is review and a response may be communicated such as the transaction is authorized or it is denied.

To enable the functionality, the point of sale device 110 may have an input output circuit which may accept the card account numbers. It also may manage communications to and from a processor and to outside networks which may be in communication with the point of sale device. The point of sale device may also have a memory which may be physically configured to store computer executable instructions. Similarly, the processor may be physically configured execute the computer executable instructions. It may have a physical card reader (mag stripe) 120, wireless account reading capability 130, a plurality of inputs 140 and a display 140 all of which may be in communication with the processor (not shown).

The point of sale terminal 110 may take on a variety of forms. A traditional point of sale device 110 is a purpose built device with a magnetic stripe reader 120, an input device such as a keypad 140, a display 150, a processor, a memory and an input-output circuit (not shown). The point of sale device 110 may also be part of a cash register, a computing device such as a personal computer or a laptop, as part of a smart phone, etc.

In some embodiments, the point of sale terminal 110 may have additional devices to facilitate a transaction such as a card reader that is in communication with a smart phone but is separable from the smart phone, a card swipe device 120 that attaches to a computer using a USB connection, etc. In addition, the point of sale device 110 may have wireless communication capabilities 130 to a work with a variety of payment devices and systems that use wireless communications. Moreover, the point of sale device 110 may have a chip reader that can communicate with a security chip that may be integrated into a payment instrument.

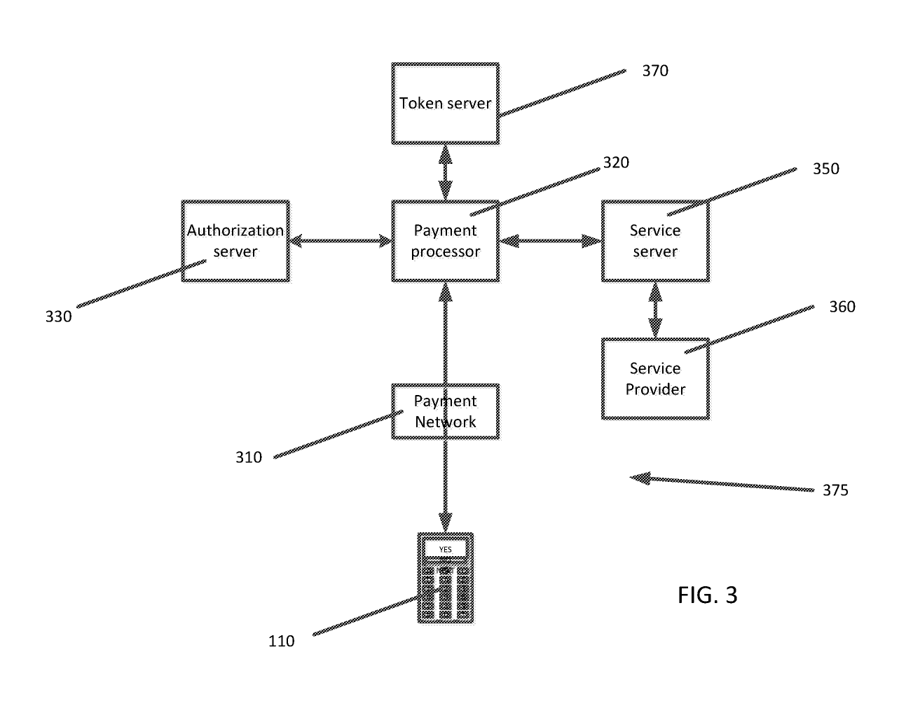

When the point of sale device 110 is activated, a physical address is often associated with point of sale device 110. The physical address is usually part of the initial setup of the point of sale device 110 along with an identification associated with the point of sale device 110. When a transaction is processed from a point of sale terminal 110, the identification is part of the communication to the payment system 310. Thus, the payment processor 310 (FIG. 3) that receives communications from the point of sale 110 terminal would be able to determine the location of the point of sale device 110.

In addition, some point of sale devices 110 may have the capability of determining an address such as GPS and the address may be communicated to the payment processing network 310. For example, the point of sale device 110 may be a portable computing device such as a smart phone and the smart phone may be able to determine its location using a GPS chip that is part of the portable computing device. Thus, even if a point of sale device 110 has an identification number assigned and is portable, the location of the point of sale device 110 may be determined.

Similarly, the point of sale device 110 may be a laptop computing device or a server type computing device. The application on the laptop may be assigned a serial number and an address may be associated with the address by a payment processor or an issuing bank. The address may be stored by the payment processor 320 such that the location of purchases may be determined.

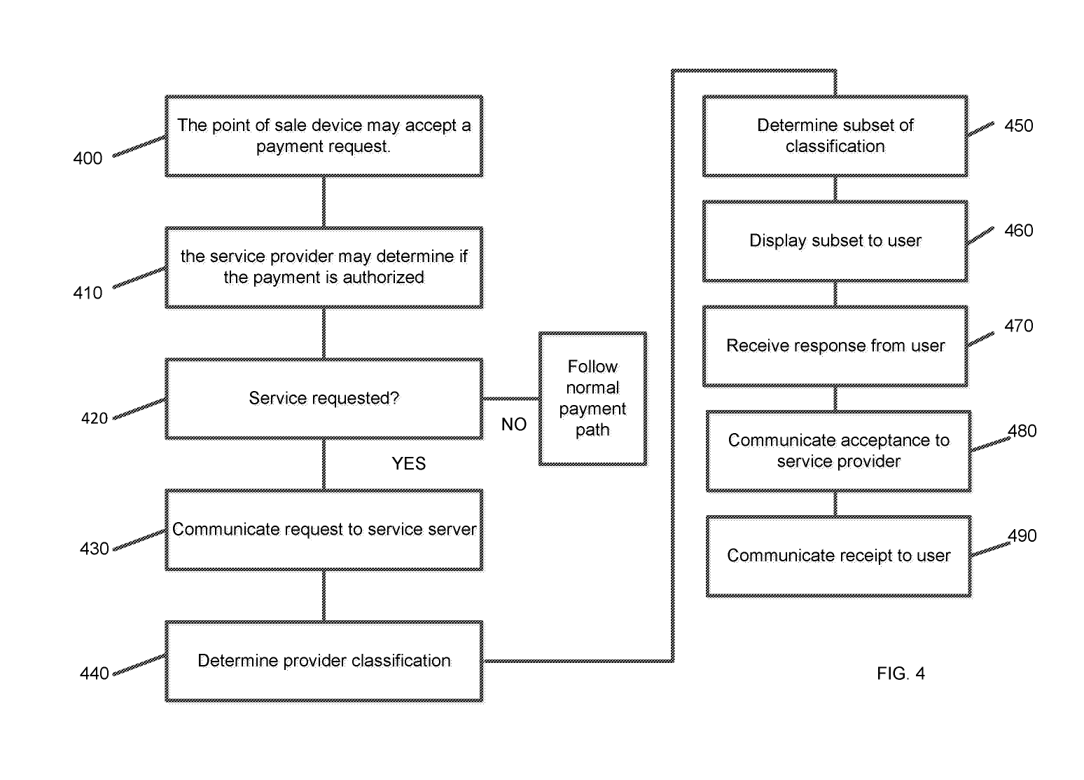

The service system 375 may use a physically modified point of sale device 210 to allow a service to be called by using the modified point of sale device 210. FIG. 4 may illustrate blocks that may be executed by the service system 375. At block 400, the point of sale device 210 may accept a payment request. The payment request may begin in a variety of ways. In one embodiment, a user may swipe a payment device such as a credit card or debit card through a credit card reader 120 where the credit card reader 120 may obtain payment data from the payer.

In other embodiments, the point of sale device 210 may read the payment data wirelessly 130. In some embodiments, the point of sale device 210 may be able to receive payment data in a variety of wireless formats such as Near Field Communications (NFC), Bluetooth, Wi-Fi, Pay Wave®, infrared, high frequency, iBeacon, etc.

In yet more embodiments, a payment application may be used to communication payment information to the point of sale device 210. A sample payment application may be Visa Checkout, for example. The payment application may use a payment token from a token server 370. The token may represent an account number such as a personal account number (PAN) which may be related to an account number of a user by a token server. The data in the token may be used to complete a transaction and may be communicated in a variety of ways, such as wirelessly, through a magnetic stripe, etc.

The data that represents a PAN may be part of the data communicated to a payment processor 320 and the service 375. In addition, an identifier of the POS 210 may be communicated. Further, in some embodiments, the address of the POS 210 may be communicated. In other embodiments, the serial number of the POS 210 may be used to match to an address that is stored in a memory at the payment processor 320 and the address may be communicated to the service system 375.

The address may take on a variety of forms. In some embodiments, the address may be GPS coordinates. In other embodiments, the address may be a street address. In yet other embodiments, the address may be latitude and longitude coordinates. In yet additional embodiments, the address may be a code that is used by the system to indicate an address that is matched by the system. In some embodiments, a combination of addresses is used such as GPS coordinates being combined with street addresses.

In other embodiments, known addresses of POS devices 205 may be given codes. The codes may be communicated to the service system where the codes may be used to determine a physical address associated with the address. The codes may be any series of characters or digits. In some embodiments, an API may be used to submit a code and receive an address in response.

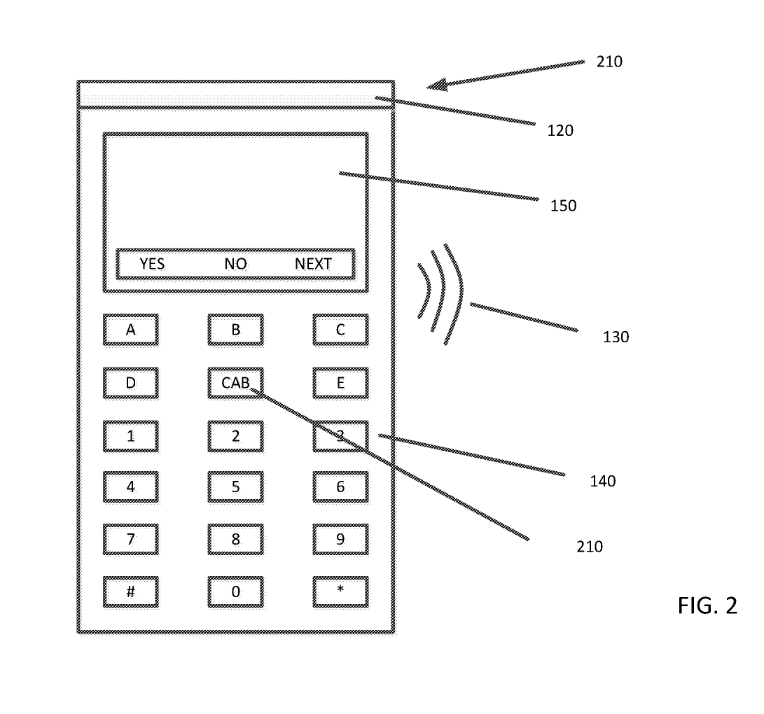

Requestor data may also be included with the POS address and may include the purchase amount and the POS 205 identifier which may be communicated to the service provider 360. Also, a service request may be provided as part of the requestor data. The service request may be provided in a variety of ways. In one embodiment as illustrated in FIG. 2, a separate button 210 may be part of the point of sale device 205 and may be used to request the service. There may be a plurality of buttons 140 with each button requesting a different service. In yet another embodiment, a graphical user interface on the display 150 may be part of the POS 210 and one or more services may be requested using the graphical user interface on the display 150. For example, the POS 210 may have a plurality of menus and different services may be selected from a plurality of categories. The POS may have a touch screen to allow the selection of services to be easier for the user. Of course, the manners of requesting an item on a graphical user interface are many and are contemplated.

In one specific embodiment, the service requested may be for a ride from a ride providing service such as a cab or another ride providing mechanism. The requestor data may include the address of the POS where the request may be where the user may desire to be picked up. As yet another example, the user may be at a grocery store and at checkout the user may select to receive a cab ride.

In some embodiments, the user interface on the POS 205 may provide additional details on the service requested. In some embodiments, an acknowledgment may be displayed on the display 150 that the service request has been received. In some additional embodiments, an estimated time that the service will begin may be provided on the display 150.

In further embodiments, the graphical user interface on the display 150 may be used to further refine the selection of services. In some embodiments, a plurality of service providers may be available. The graphical user interface on the display 150 may be used to display potential service providers and the user may be able to select one of the providers from the plurality of providers. Similarly, the graphical user interface on the POS 210 may show ratings on the service providers.

In another aspect, a map may be displayed that illustrates a requested service location and a user may indicate on the map the location where the requestor would like the service to occur. For example, the requestor may indicate on the map where they would like the service provider to pick them up in a car service.

In yet another embodiment, a portable computing device may be used as part of the service request. As mentioned previously, a portable computing device itself may act as the POS 205 and the many functions and interfaces may be part of the service provider interface. In yet another embodiment, the POS 105 may be traditional card swipe POS and the user portable computing device may be used in conjunction with the traditional POS swipe device.

For example, a card swipe device 205 may not have a graphical user interface but a portable computing device such as a smart phone may be used as the graphical user interface. Data may be communicated via a cellular communication or via a Wi-Fi network. In another embodiment, the data may be communicated from the POS 205 to the smart phone via a wireless communication format. In yet another embodiment, the data may be communicated by Wi-Fi, Bluetooth or any other manner of communication with the POS 205 and the portable computing device.

In another aspect, the service provider may receive the requestor information through the input output circuit and may store it in a memory. As mentioned previously FIG. 4 may illustrate a sample flow of computer executable instructions that may physically configure a processor. At block 410, the service provider may determine if the payment is authorized by communicating the payment data which may include the purchase amount, the purchaser and the vendor to an authorization server. The authorization server may subject the payment data to a variety of tests and may determine a level of confidence whether the transaction should be authorized.

At block 420, the message may be reviewed to determine if a service is requested. If a service is requested, at block 430 the message may be communicated to a service server which may be configured according to additional computer executable instructions. The service server may analyze the service request and at block 440 may determine the relevant classification of vendors to receive the service request. For example, if a cab is requested, car providers may be the category and a variety of car providers may be queried to locate an acceptable car provider.

In some embodiments, at block 450 the system may review the category of vendor to determine a subset of appropriate vendors. For example, if a first vendor is located a significant distance from the user, the first vendor may not be included in the sub-set of vendors. Similarly, a first vendor that is currently occupied may not be included in the subset of appropriate vendors.

At block 460, the subset of appropriate vendors may be then communicated to the user. The subset may include additional information about each vendor in the subset such as the rating the vendor has received, the distance the vendor is from the requesting location, the time is should take the vendor to get to the service location, the price the vendor charges for the service, etc.

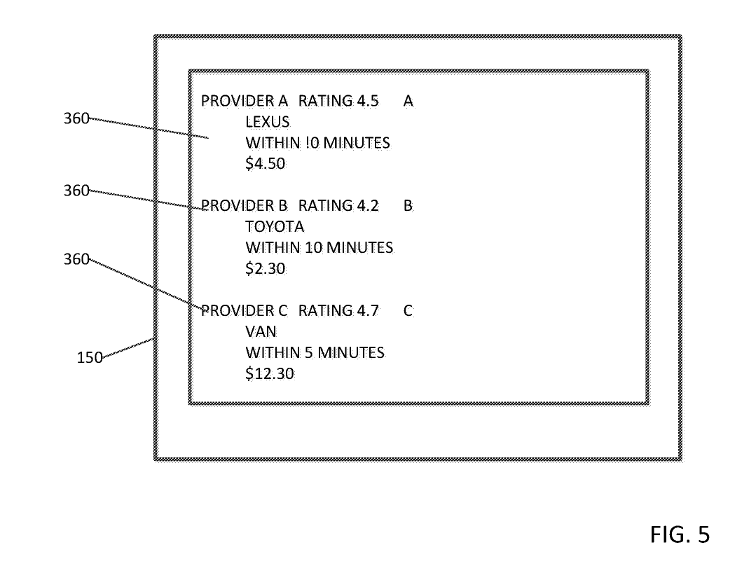

FIG. 5 may be an illustration of a sample user interface provided to a user. Of course, the backend server may track feedback information and may provide the information to the users. Similarly, the response server may communicate the request for service to the subset, receive the responses, determine an order to the responses and communicate the responses to the user. The order of the responses may be set by the system or may be selected by a user. For example, a user may select that the responses be ranked by the lowest cost to the highest cost while another user may select to have the responses ranked by the shortest response time to the longest response time. Of course, different response rankings and combinations of rankings and weighting are possible and are contemplated.

At block 470, the backend server may receive a response from the user. In one embodiment, the user may select a service provider from a plurality of service providers.

At block 480, the backend server may then communicate the acceptance to the service provider. The communication to the service provider may occur in a variety of ways. In some embodiments, the service provider may have a portable computing device such as a smart phone which may be able to receive data in a variety of ways, such as cellular communication, Wi-Fi communication, Bluetooth communication, or any other wireless communication form and format that may be appropriate. In another embodiment, the service provider may have a purpose built computing device in the vehicle to assist in providing the service such as a modified cab billing device. In another embodiment, the user may have a dedicated computer that uses one of more communication forms to receive, communicate and display data.

At block 490, the backend server may communicate to the user that the service has been scheduled. Details of the service may also be provided such as the details of car, details of the driver, details of the manner to contact the service provider, details of the time for pickup, details for the time of arrival, the projected cost, etc.

In another embodiment, the user may request more information about one the service providers. For example, the user may desire to know about the type of car the service provider is driving. The backend server may retrieve the requested information and provide it to the user. If the requested information is not known, the lack of data may be communicated to the user also. Once the user accepts a service provider, the method may continue as described in blocks 450-490.

The information may be received through a payment network 310. The payment network 310 may be a special built, limited access network that primarily carries payment data. The payment data may be in a known format and may be communicated along predictable paths. Carrying non-payment data over a payment network may be a technical challenge. In one embodiment, the data is encoded as payment data and is carried over the payment network 310 like traditional payment data. In another embodiment, the data for the system is noted as not being payment data but is acceptable data to be carried on the payment network 310. In each embodiment, the service data being on a payment service 310 is a technical challenge which requires a technical solution, some of which have been mentioned previously.

In response to the service being complete, the service server may notify the parties to the transaction that the transaction is complete. Specifically, the service provider may receive the appropriate sums for providing the transaction. Similarly, the servicer requester may have to pay the appropriate amount for the service. The actual from of money or value may proceed through the traditional payment network and the service provider may receive notice similar to a store being notified that a transaction has been settled. .

The user devices, computers and servers described herein may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A point of sale device comprising
an input output circuit to receive requester data from a payment device;
a memory to store the requester data and POS location data; and
a processor physically configured according to computer executable instructions to:
communicate a request for a service via the input output circuit comprising
communicating the requester data and the POS location data to a receiving computing device to request the service.

2. The point of sale device of claim 1, wherein requestor data further comprises a personal account number.

3. The point of sale device of claim 2, wherein a personal account number comprises a short term account number from a token service.

4. The point of sale device of claim 1, wherein the POS location data comprises at least one of:
Global Positioning System coordinates;
a street address;
a code that relates to a physical address; and
a code that relates to a GPS coordinates.

5. The point of sale device of claim 1, wherein the requester data is communicated via a payment network.

6. The point of sale device of claim 1, further comprising communicating the requester data to the receiving computing device which routes the service request to a determined service provider selected from a plurality of service providers.

7. The point of sale device of claim 1, wherein the processor is further configured for:
receiving a response from at least one service provider;
displaying the response to the requester.

8. The point of sale device of claim 7, wherein the response further comprises a service delivery time.

9. The point of sale device of claim 7, wherein the response comprises:
a plurality of service providers;
a price for each of the service providers.

10. The point of sale device of claim 7, wherein the processor is further configured to
receive a selection of a service provider;
communicate the selection to the receiving computing device wherein the receiving computing device notifies the winning service provider that the service is required and notifies the non-winning service providers that the service is not required.

11. The point of sale device of claim 2, further comprising:
communicating the payment data to an authorization server;
receiving an authorization message from the authorization server;
if the authorization is approved, communicating the payment data to the service provider and the requester;
if the authorization is not approved, communicating the not approval to the service provider and to the requester.

12. The point of sale device of claim 1 further comprising computer executable instructions that physically configure the processor to:
display a plurality of service classes;
receive a selection of a selected service class;
communicate the selected service class to the receiving computing device;
determining appropriate service providers that are capable of providing the selected service class;
receiving responses from the appropriate service providers; and
displaying the responses to the requester.

13. A point of sale control system comprising
A point of sale device comprising:
an input output circuit to receive requester data from a payment device;
a memory to store the requester data and POS location data; and
a processor physically configured according to computer executable instructions to:
communicate a request for a service via the input output circuit comprising
communicating the requester data and the POS location data to a receiving computing device to request the service; and
a receiving computing device comprising
a receiving input output circuit to receive the request for the service;
a receiving memory to store computer executable instructions;
a receiving processor physically configured according to the computer executable instructions to:
analyze the request data;
analyze the POS location data;
determine which a service provider from a plurality of service providers to alert to the request for service.

14. The point of sale control system of claim 13, wherein a personal account number comprises a short term account number from a token service.

15. The point of sale control system of claim 13, further comprising computer executable instructions that physically configure the processor in the point of sale device to:
display a plurality of service classes;
receive a selection of a selected service class;
communicate the selected service class to the receiving computing device;
determining appropriate service providers that are capable of providing the selected service class;
receiving responses from the appropriate service providers; and
displaying the responses to the requester.

16. A computerized method for providing additional services from a point of sale (POS) device comprising receiving requester data from a payment device;
storing in a memory of the POS device the requester data and POS device location data; and
communicating a request for a service based on the requester data and the POS device location data to a receiving computing device to request the service.

17. The computerized method of claim 16, wherein the requester data is communicated via a payment network.

18. The computerized method of claim 16, further comprising communicating the requester data to the receiving computing device which routes the service request to a determined service provider selected from a plurality of service providers.

19. The computerized method of claim 18, further comprising:
receiving a response from at least one service provider;
displaying the response to the requester.

20. The computerized method of claim 19, further comprising:
receiving a selection of a service provider; and
communicating the selection to the receiving computing device wherein the receiving computing device notifies a winning service provider that the service is required and notifies non-winning service providers that the service is not required.
